(19) United States
(12) Patent Application Publication
(10) Pub. No.: US 2003/0200110 A1
(43) Pub. Date: Oct. 23, 2003

(54) Interindividual settlement support method

(75) Inventors: Naohiro Munechika, Tokyo (JP); Kinji Iwatate, Tokyo (JP); Kanjiro Sato, Tokyo (JP); Hiroshi Muramatsu, Tokyo (JP); Motoharu Suzuki, Tokyo (JP); Miyuki Yamazaki, Tokyo (JP); Yuki Watabe, Hokkaido (JP)

Correspondence Address: STAAS & HALSEY LLP, SUITE 700, 1201 NEW YORK AVENUE, N.W., WASHINGTON, DC, 20005, US

(73) Assignee: Nifty Corporation, Tokyo (JP)

(21) Appl. No.: 10/378,075

(22) Filed: Jun. 4, 2003

(30) Foreign Application Priority Data
Mar. 4, 2002 (JP) 2002-057924

(51) Int. Cl. G06F 17/60

(52) U.S. Cl. 705/1

(57) ABSTRACT

When a browser on a user terminal operated by a seller sends a file of a content to be sold or a link destination URL, indicating the location of the content and information designating its sale price and charging condition to a WWW server on a support server machine, a product registration CGI generates a unique product number, stores thus generated product number, the sale price and the charging condition, path to the file of the content to be sold or the link destination URL in a product information table with then corresponding to one another, issues a product URL including the generated product number and URL of the sale CGI, and sends the product URL to the user terminal. When a browser on a user terminal operated by the purchaser then sends this product URL to the WWW server, a sale CGI and charging system executes processes to charge the purchaser the sale price stored in the product information table corresponding to the product number in the product URL according to the charging condition and notifies the user terminal of the path to the file or the link destination URL.

### BACKGROUND OF THE INVENTION

1. Field of the Invention

The present invention relates to an interindividual settlement support method for mediating in purchasing a content between individuals and for charging a purchaser its sale price via a network such as the Internet, etc.

2. Description of the Prior Art

As networks such as a personal computer communication network and the Internet becomes popular, it has become possible for individuals that have created content with commercial value to sell such content to a broad range of third parties through the network. Such a content having been sold via a network may be, for example, image data such a photographs or illustrations, music data such as MIDI or MP3 files, text data such as novels or current affairs reports, etc., or computer programs referred to as shareware.

In the most simple form of merchandising content between individuals via a network, a seller and a prospective purchaser contact each other directly. The prospective purchaser transfers a purchasing price for the content to the bank account of seller, and thereafter the seller sends an e-mail appended with this content to the prospective purchaser. With this kind of transaction method, the procedures the people concerned have to carry out are complicated. To resolve the problem, a system is implemented, where an administrator administering the personal computer communication network or an administrator administering an internet connection service, who is an ISP: Internet Service Provider, mediates in the sale of the content between members registered through an application designating a bank account number or credit card number, and collects the price of the content purchased by one member from the purchaser with his or her membership fee.

However, in the aforementioned system, the sale price (or licensing fee) for the entire content is charged the purchaser in a lump at the time of purchase. It is therefore not possible for the charge to reflect the intentions of the purchaser or the quality of the content being purchased. More specifically, as to contents such as pay electronic bulletin boards or pay web pages where the content is updated periodically or occasionally, periodic charging of sale price as membership tee is more suitable to their attributes than charging the purchasers a sale price for the entire content in a lump at the time of purchase. But, such charging is not possible in the existent system. Besides, as to contents such as a computer program, the seller may with to periodically charge the purchasers a rent as long as the purchasers uses the content rather than charging the purchasers a sale price in a lump at the time of purchase. But, it is not possible to charge in this manner in the existent system.

### SUMMARY OF THE INVENTION

In order to resolve the problems encountered with the existent system, the present invention provides an interindividual settlement support method where a charging method reflecting the intent of the seller or the attributes of a content to be sold can be arbitrarily selected and set by the seller.

Accordin to the interindividual settlement support method of the present invention, a computer is able to execute a first program of processes for communicating with terminals to mediate in purchasing a content between individuals and a second program of processes for charging a purchaser sale price of the content. The first program makes the computer stores identification information, and information indicating a sale price and a charging condition for a content requested by a seller in a first storage device with them corresponding each other, and read, when receiving a purchase request designating the identification information from a terminal operated by a purchaser, information indicating the sale price and charging condition corresponding to this identification information from the first storage device to store a record including the read information and the identification information indicating the purchaser in a second storage device. The second program makes the computer charge the purchaser indicated by the identification information the sale price indicated by the information according to the charging condition indicated by the information, said prices of information being included in same record stored in the second storage device.

With this configuration, if only the seller specifies the sale price and the charging condition at the time he or she requests the service provider who provides the service according to present invention to act as a fee collecting agent for the content to be sold, information indicating the sale price and the charging condition is stored in the first storage device together with identification information for this content. Thereafter, when the computer receives a purchase request designating the identification information for this content, the sale price and charging condition corresponding to the designated identification information is read from the first storage device, and a record including these pieces of information and identification information for the purchaser is stored in the second storage device. The sale price is then charged to the purchaser according to the charging condition for every record stored in the second storage device. It is therefore possible for the seller to charge the purchaser the sale price of the content according to the charging condition that is appropriate for the attributes of the content to be sold or appropriate for the intent of the purchaser.

As examples of charging condition, charging of the sale price in a lump at the time of purchase (or day of settlement), repeatedly and periodically charging a fixed sale price, or repeatedly and periodically charging a fixed sale fee after a prescribed period has elapsed may be given.

Notification of identification information of the content may be given by the seller or may be automatically generated, as long as this information is unique.

### BRIEF DESCRIPTION OF DRAWINGS

The invention will be described below in detail with reference to the accompanying drawings, in which:

FIG. 1 is a block diagram of a network system constituting a first embodiment of the present invention.

FIG. 2 is a table showing a schematic data structure of a member management table.

FIG. 3 is a table showing a schematic data structure of a seller information table.

FIG. 4 is a table showing a schematic data structure of a product information table.

FIG. 5 is a table showing a schematic data structure of a purchasing information table.

FIG. 6 is a table showing a schematic data structure of a deposit list.

FIG. 7 is a view showing a top page of an interindividual sales system.

FIG. 8 in a flowchart showing processes according to a usage accepting CGI.

FIG. 9 is a flowchart showing a first authentication process based on an authentication system.

FIG. 10 is a flowchart showing process according to a product registration CGI.

FIG. 11 is a flowchart showing a second authentication process based on an authentication system.

FIG. 12 is a flowchart showing processes according to a product CGI.

FIG. 13 is a flowchart showing charge process based on a charging system.

FIG. 14 is a flowchart showing process according to a bank transfer management CGI.

FIG. 15 is a flowchart showing bank transfer process based on a charging system.

FIG. 16 is a view showing an authentication screen.

FIG. 17 is a view showing an basic information input screen.

FIG. 18 is a view showing a product newly setting screen.

FIG. 19 is a view showing a product installation method selection screen.

FIG. 20 is a view showing a product file upload screen.

FIG. 21 is a view showing a registration confirmation screen (in a case sales method=0).

FIG. 22 is a view showing a link destination URL designation screen.

FIG. 23 is a view showing a registration confirmation screen (in a case sales method=1).

FIG. 24 is a view showing an example of setting product URL to a seller's web page.

FIG. 25 is a view showing a product sale screen (in a case sales method=0).

FIG. 26 is a view showing a download screen.

FIG. 27 it a view showing a product sale screen (in a case sales method=1).

FIG. 28 is a view showing a link screen.

FIG. 29 is a view showing content located on a seller's web page.

FIG. 30 is a view showing a bank transfer designation

### DESCRIPTION OF THE PREFERRED EMBODIMENT

Hereinafter, an embodiments of an interindividual settlement method according to the present invention will be described with reference to the drawings.

(System Configuration)

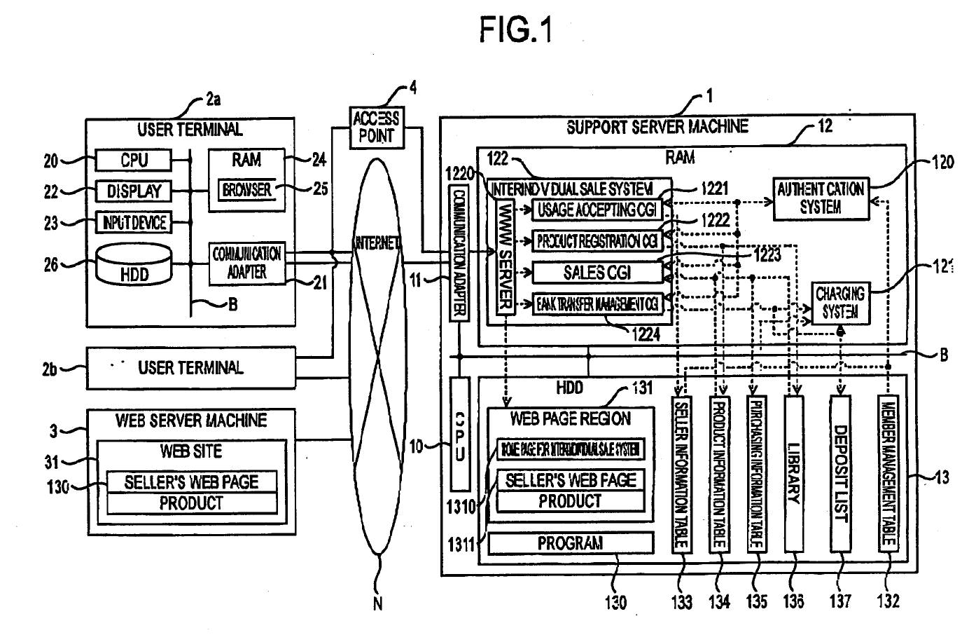

FIG. 1 is a block diagram showing a schematic configuration of a network system implementing the individual settlement method. As shown in FIG. 1, this network system includes a single support server machine 1 constructed in order to implement the interindividual settlement method according to the present invention, a plurality of web server machine 3 (only one of which is shown in FIG. 1) for publishing web pages, and a plurality of user terminals 2 (only two 2a, 2b of which are shown in FIG. 1). The support server machine 1 is managed by an administrator (hereinafter referred to as “service provider”) providing an internet connection service (ISP) and pay content providing service and is a device for providing each of the services to the user terminal 2 operated by a member being under contract with this service provider (hereinafter referred) to simply an “member”) and for publishing web content (HTML data, other digital content) on the Internet N regardless of access rights. In FIG. 1, just a single computer is shown as the support server machine 1 for simplicity of description but respective function possessed by the support server machine 1 may also be distributed to individual computers administered by the service provider or individual functions may be distributed among a plurality of computers.

Each of the user terminals 2a and 2b shown in FIG. 1 are computers operated by members being under contract with the service provider. It is therefore possible to connect to the support server machine 1 by a gateway connection via the Internet N or an access point connection via an access point 4. Each of the user terminate 2a and 2b can also access other web server machines 3 either via the Internet N or via an internet connection service provided by the support server machine 1 connected via the access point 4.

Each user terminal 2a and 2b (in FIG. 1, illustration of inside of the user terminal 2b is omitted) is a computer capable of being connected to the Internet N, which has, for example, a CPU (Central Processes Unit) 20, a communication adapter 21, a display 22, an input device 23, a RAM (Random Access memory) 24 and a hard disk 26, connected to one another through a bus B. The CPU 20 is a central processes unit for controlling the whole of the user terminal 2. The communication adapter 21 is a device for providing a physical interface with a line connecting to the access point 4 or the internet N via unillustrated other ISP, which is specifically a modem, TA (Terminal Adapter), or router, etc. The display 22 is a display device for displaying images generated by the CPU 20. The input device 23 may be keyboard or mouse. The RAM 24 is a main storage device in which a work area used by the CPU 20 to execute respective programs is developed.

The hard disk 26 stores some categories of programs read out and executed by the CPU 20. The programs stored in the hard disk 26 include an operating system (not shown) effectuating a function of carrying out communication in accordance with TCP/IP (Transmission Control Protocol/Internet Protocol) between the support server machine 1 and other web server machines 3 via the communication adapter 21 and a browser 25 for sending various messages to the support server machine 1 using the communication function of the operating system 26 and interpreting and displaying web content (image data consisting of HTML: Hyper Text Markup Language data etc.) sent by the support server machine 1 in accordance with these messages. The browser 25 is a typical commercial browser program such as Microsoft Internet Explorer (registered trademark of Microsoft Corporation (US)), so that a detailed description of the processes content of such a browser is omitted here.

Other web server machines 3 also execute internet web server programs so that web sites 31 publishing various web content (HTML data and other digital content) can be constructed therein.

The support server machine 1 is described as being a sin le computer and therefore has a CPU 10, communication adapter 11, RAM 12 and hard disk 13. The CPU 10 is a central processes device for controlling the whole of the support server machine 1. The RAM 12 is a main storage device in which a work area used by the CPU 10 to execute respective processes is developed. The communication adapter 11 is a communication device for providing an interface to the lines (that is, internet backbone) constituting the internet N or the lines (that is, WAN: Wide Area Network) connected to the access point 4. The hard disk 13 is a storage device which stores each program 130 and various data read out and executed by the CPU 20.

Various programs 130 stored in the hard disk 13 include the interindividual sales system 122 as the first program for implementing the inter individuals settlement support method according to the present invention, in addition to a system (not shown) for implementing internet connection services and pay content providing service that are the original function of the support server machine 1, an authentication system 120 originally programmed for authenticating members requesting these services, and a charging system 121 as the second program originally programmed for charging fees for each service to each accessing member. The interindividual sales system 122 specifically has a typical WWW server program 1220, a usage accepting CGI: Common Gateway Interface 1221 activated when an HTTP request message designating a URL corresponding to the WWW server program 1220 is received, a product registration CGI 1222, a sales CGI 1223 and a bank transfer management CGI 1224.

Each of these programs are executed while sequentially read from the hard disk 13 onto the RAM 12. In FIG. 1, it is assumed that the capacity of the RAM 12 is extremely large and the situation is shown, where all of the programs are being run on the RAM 12 (however, the system for implementing the internet connection service and pay content providing service is omitted from the drawings).

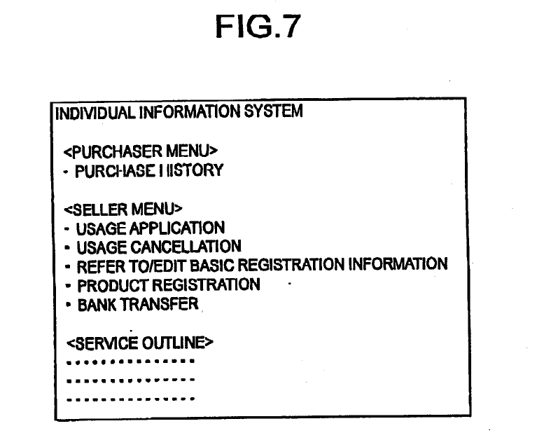

The data stored in the hard disk 13 include those in a web page area 131 for storing static web page data (including HTML data 1310 for displaying the top page of the inter individual sales system 122 shown in FIG. 7) which the WWW server 1220 can directly read in response to HTTP request messages sent from an user terminal 2 to send back to the user terminal 2 (without using any CGI), a member management table 132 referred to by the authentication system 120 and the sales CGI 1223, where records are registered by the system for implementing the internet connection service and the pay content providing service, a seller information table 133 referred to by the authentication system 120, where records are registered by the usage accepting CGI 1221 , a product information table 134 referred to by the sales CGI 1223, in which records are registered by the product registration CGI 1222, a purchasing information table 135 referred to by the charging system 121, in which records are registered by the sales CGI 1223, a library 136 for storing sales target content (referred to in the following as “product”) uploaded by the product registration CGI 1222 and downloaded only by the sales CGI 1223, and a deposit list 137 referred to by the charging system 121 and thc bank transfer management CGI 1224, in which data are updated by the charging system 121. In FIG. 1, flows or information between programs 130 running on the RAM 12 and data within the hard disk 13 are shown by broken lines.

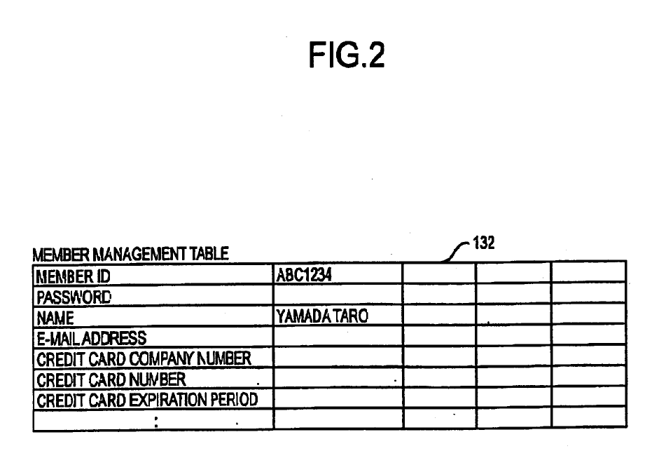

FIG. 2 is a table showing a schematic data structure of the member management table 132. As shown in FIG. 2, a record for each member containing information such as a member ID as an identification for the member, a password corresponding to the member ID, a member name, e-mail address of the member, a credit card company number for identifying the company issuing a credit card which the member has and which is designated by the administrator for settlement of the tees and the card number and expiration period of this credit card, etc. is recorded in the member management table 132.

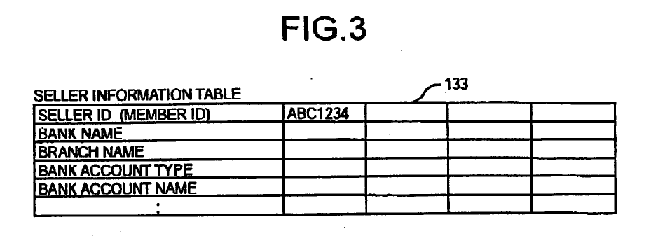

FIG. 3 is a table showing a schematic data structure of the seller information table 133. As shown in FIG. 3, a record for each member who applies to sell products through the interindividual sales system 122 (hereinafter referred to as a “seller”) containing information such as a seller ID (matched against the member ID) as an identification for the seller, the bank name, branch name, account type, account name and account number of a bank account designated by the seller for transfering sales price of products, etc. is recorded in the seller information table 133.

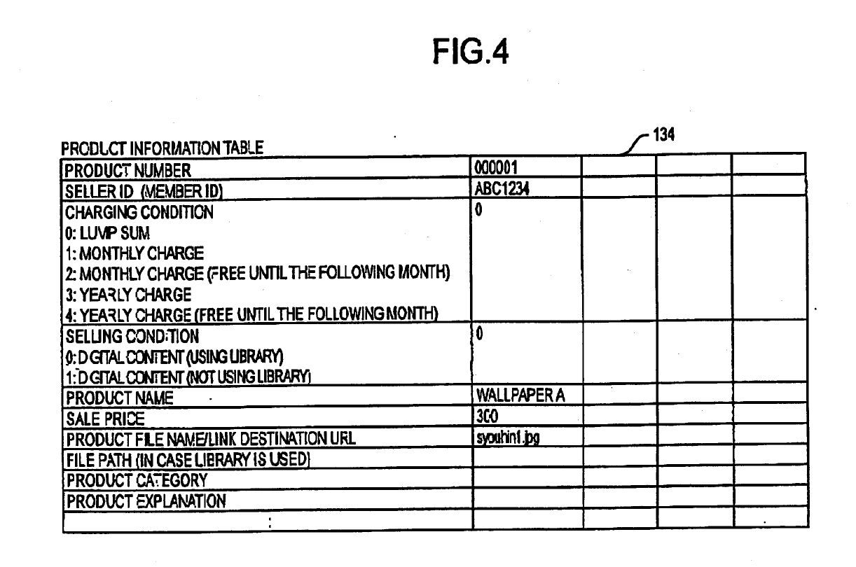

FIG. 4 is a table showing a schematic data structure of the product information table 134. As shown in FIG. 4, a record for each product which each seller wishes to sell containing information such as a product number as an identification for the product, a seller ID of the seller of the product, charging condition for specifying the charging method for the price of the product, selling condition specifying whether or not to use the library 136 in selling this product (which corresponds to the information indicating a charging condition), product name of the product, a sele price (which is an amount collected on each billing when the charging condition is monthly or yearly) of this product, a file name (in a case the selling condition specifies to use the library) or URL (in a case the selling condition specifies not to use the library) of this product, the path to the file of the product within the library 136, a category of this product, and an explanation of this product, etc. is recorded in the product information table 134. The portion storing the product information table 134 in the hard disk 13 corresponds to the first storage device.

As a value indicating the charging condition, “0” is set in the case where the price of the product in charged as a lump sum at each time the product is sold, “1” is set in the case of a monthly charge where the price at the product is charged monthly as a usage fee or as a license fee as long as its purchaser uses it, “2” is set in the case of the monthly charge where the monthly charged price is free up to the next month of the deal, “3” is set in the case of a yearly charge where the price of the product is charged yearly as a usage fee or as a license fee as long as its purchaser uses it, and “4” is set in the case of the yearly charge where the yearly charged price is free up to the next month of the deal. As a value indicating selling condition, “0” is set when the seller entrusts distribution (downloading) to the interindividual sales system 122 (sales CGI 1223) with his or her product stored in the library 136, and “1” is set when the distribution is managed by the seller himself or herself with his or her product allocated on his or her web pages 1311, 310 stored in a web page region 131 within the support server machine 1 or in a web site 31 within another web server machine 3. In the latter case (selling condition=“1”) , direct access with escaping the interindividual sales system 122 (the sales CGI 1224) is prohibited by inappropriate access prevention means set up separately.

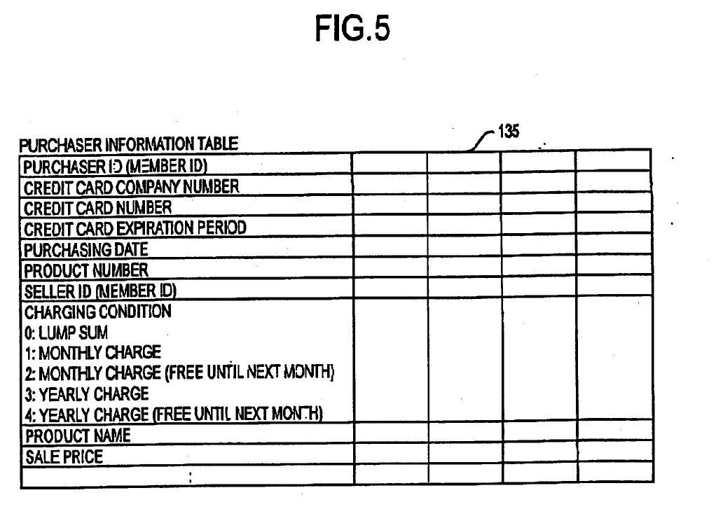

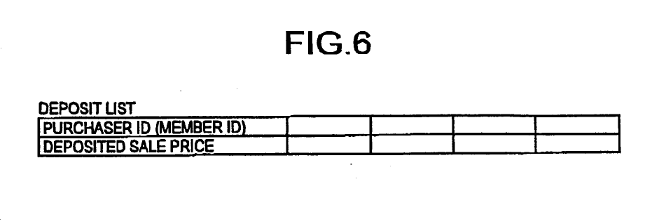

FIG. 5 is a table showing a schematic data structure of a purchasing information table 135. As shown in FIG. 5, a record for each transaction through the interindividual sales system 122 (sales CGI) containing information such as a purchaser ID (which is the member ID of the purchaser) as an identification of the purchaser, a credit card company number, card number and expiration period of the credit card designated for settlement of charged price by the purchaser, a purchasing date showing the date of this transaction, a product number of the product, a seller ID of its seller, charging condition, a product name and a selling price etc. are recorded in the purchasing information table 135. The portion storing the purchasing information table 135 in the hard disk 13 corresponds to the second storage device

The library 136 is uploaded with product files of which selling condition=0, and has a hierarchical internal structure, with a storage position of each product file being specified by paths tracing the hierarchical structure. The product file stored in the library 136 can only be rend by the sales CGI 1223 and cannot be accessed by the WWW server 1220.

The deposit list 137 is recorded, for every seller ID recorded in the seller information table 134, with amount of deposited sale price which have been charged to its purchasers but are yet to be transferred to the bank account of the seller.

(Processes Content)

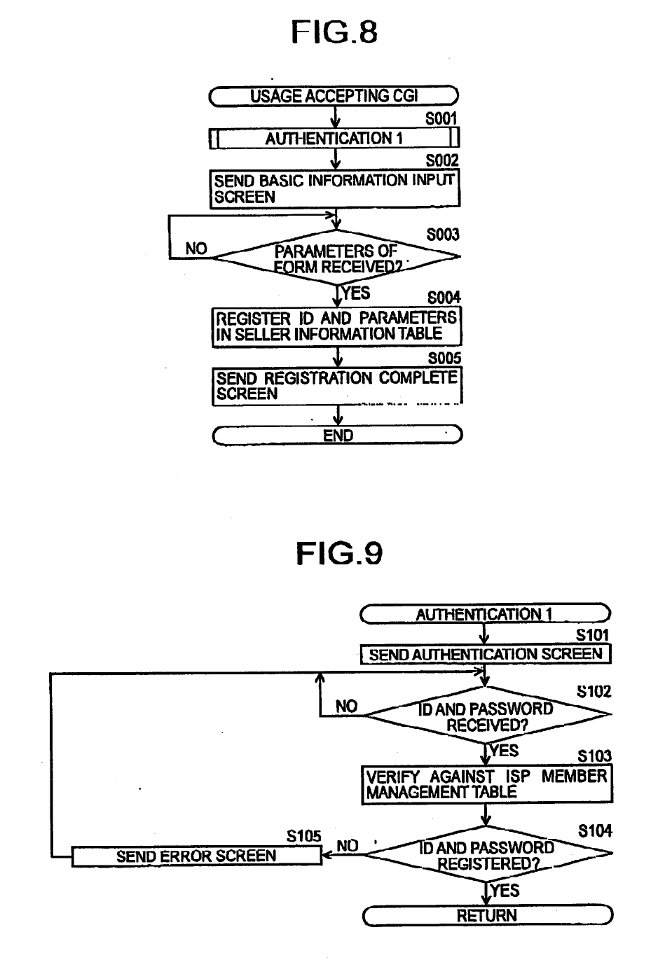

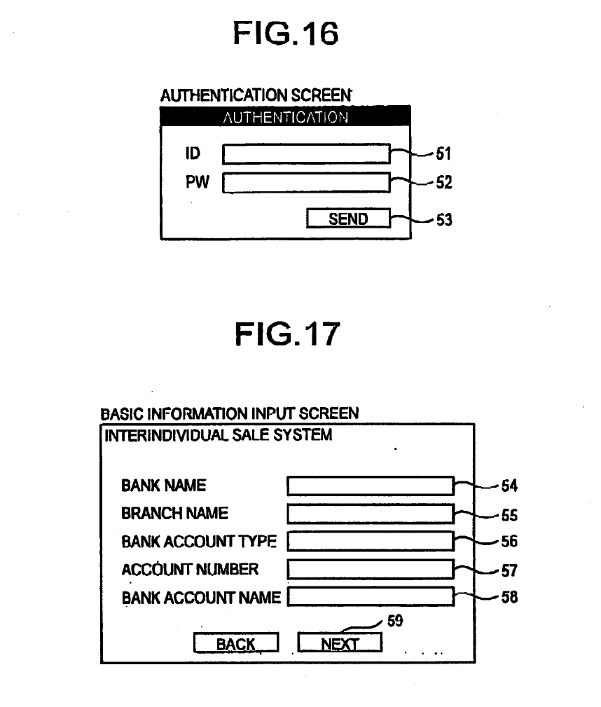

Hereinafter, the contents of processes executed based on each of the CGI programs 1221 to 1224, the authentication system 120 and the charging system 121 respectively constituting the interindividual sales system 122 will be explained, with reference to, in addition to each of the above drawings, the flowcharts in FIG. 8 to FIG. 14, and the exemplary screens of FIG. 16 through FIG. 29. In the following description, the user terminal 2a is operated by a member as the seller and the user terminal 2b is operated by a member who is the purchaser

In advance of execution of processes based on the usage accepting CGI 1221, the product registration CGI 1222 and the bank transfer management CGI 1224, the browser 25 running on the user terminal 2a sends an HTTP request message designating a URL of the top page of the interindividual sales system to the WWW server 1220 on the support server machine 1 in accordance with information input by a member with the input device 23, and the WWW server 1220 reads out HTML data 1310 of the top page or the interindividual sales system from the web page region 131 of the hard disk 13 and responds it to the browser 25 of the terminal 2a. As a result, the browser 25 displays the top page of the interindividual sales system shown in FIG. 1 on the display 22 based on the received HTML data 1310. Various items are provided on the top page of the interindividual sales system. A link (href in an anchor tag) to a URL of the usage accepting CGI 1221 is set to the item for “usage application”. A link (href in an anchor tag) to a URL of the product registration CGI 1222 is set to the item for “product registration”. A link (href of an anchor tag) to a URL of the bank transfer management CGI 1224 is set to the item for “bank transfer”.

When the item for “usage application” is clicked as a result of the member operating the input device 23 (more specifically, pressing a click button with the cursor overlaid on this item with a mouse constituting the input device 23), an HTTP request message designating the URL of the usage accepting CGI 1221 is sent to the WWW server 1220. The WWW server 1220 receiving the HTTP request message then activates the usage accepting CGI 1221. AS shown in the flowchart in FIG. 8, the usage accepting CGI 1221 activated in this manner makes a request to the authentication system 120 for a first authentication processes, in a first step S001.

The first authentication processes shown in the flowchart of FIG. 9 is an existing process executed by an authentication system 120. In a first step S101 after receiving the request, the authentication system 120 sends HTML data for displaying an authentication screen shown in FIG. 16 to the browser 25. This HTML data is incorporated with settings (i.e., a form tag) for indicating an ID box 51, a password box 52 and a “send” button 53 in the authentication screen as shown in FIG. 16, and for sending two character strings individually inputted to the ID box 51 and the password box 52 to the authentication system 120 as the member ID and password when the “send” button 53 is clicked. Therefore, in next stop S120, the authentication system 120 waits for the member ID aid password to be sent from the browser 25.

When the member ID and the password are received from the browser 25, the authentication system 120 verities, in step S103, the received member ID and password with all combinations of the member IDs and passwords registered in the member management table 132, and checks, in step S104, whether or not the combination of the received member ID and password is registered in the member management table 132. If the received combination of member ID and password is not registered in the member management table 132, the authentication system 120 sends, in step S105, HTML data for displaying an error screen (not shown) to warn that the inputted member ID and password are not registered and to suggest that the information be re-input or that an application for admission be made to the browser 25, and returns the processes to step S102. On the contrary, if the combination of the received member ID and password is registered in the member management table 132, the authentication system 120 answer to the usage accepting CGI 1221 that the operator of the accessing user terminal 2 is authenticated an a member, together with the member ID of this member.

When it is confirmed that a member accesses it, the usage accepting CGI 1221 sends, in next step S002, HTML data for displaying a basic information input screen shown in FIG. 17 to the browser 25. This HTML data is incorporated with settings (i.e., a form tag) for indicating the bank name box 54, the branch name box 55, the type of bank account box 56, the account number box 57, the account name box 58 and the “next” button 59 in the screen and for sending character strings inputted to each of the boxes 54 to 58 to the usage accepting CGI 1221 as the bank name, branch name, type of bank account, account number, and account name when the “next” button 59 is clicked. Therefore, in next step S003, the usage accepting CGI 1221 waits for each item of information to be sent from the browser 25.

When each item of information in received from the browser 25, the usage accepting CGI 1221 stores, in next step S004, a new record storing the member ID of the member authenticated in step S001 and each item of information received from the browser 25 in step S003 in the seller information table 134.

In next step S004, the usage accepting CGI 1223 sends HTML data for displaying an indication that the member is registered as a seller to the browser 25 and thereafter finishes all of the processes. Thereafter, the member operating the user terminal 2a is handled as a “seller”, in the connection with the interindividual sales system 122.

When a seller registered in the seller information table 133 au described above clicks the item for “product registration” in the top page of the interindividual sales system shown in FIG. 7 displayed on the display 22 of the user terminal 2a, a HTTP request message designating the URL of the product registration CGI 1222 is sent to the WWW server 1220. The WWW server 1220 receiving the HTTP request message then activates the product registration CGI 1222.

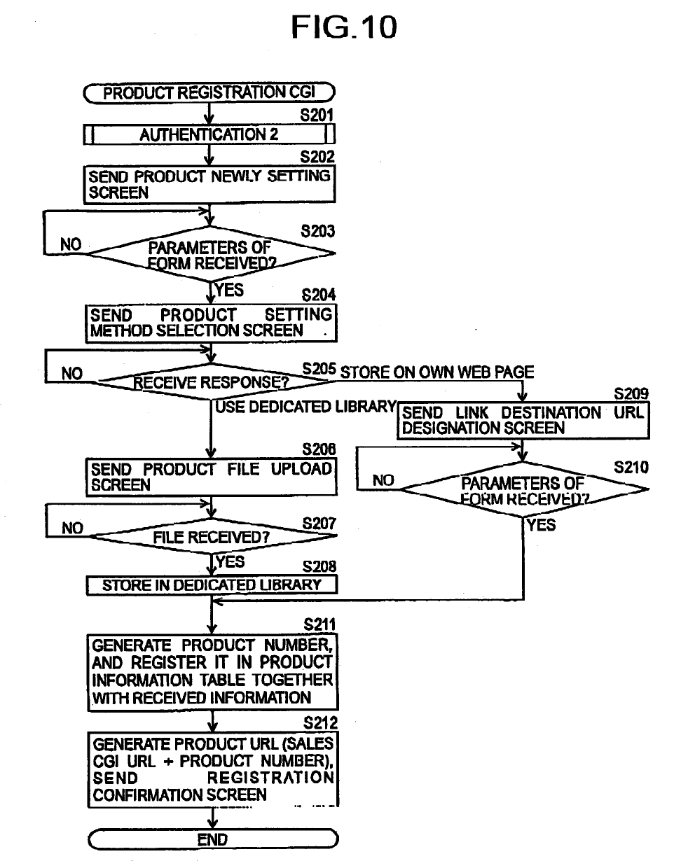

As shown in the flowchart in FIG. 10, in a first step S201, the product registration CGI 1222 thus activated then makes a request to the authentication system 120 for a second authentication processes.

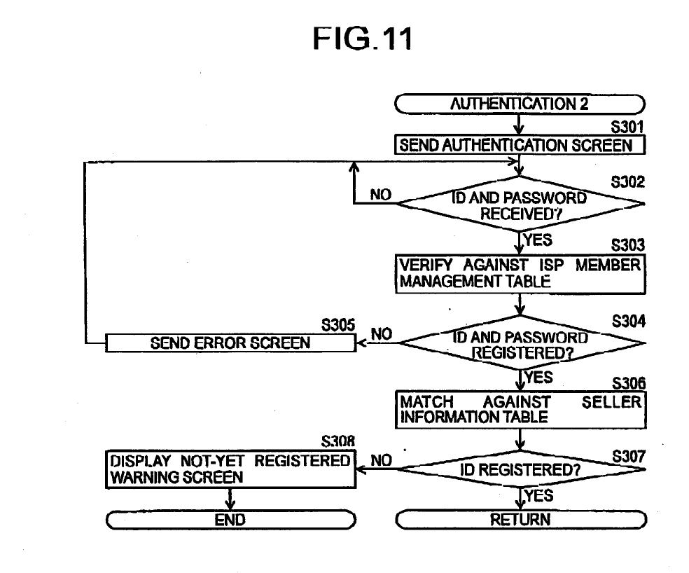

The second authentication processes shown by the flowchart in FIG. 11 is a function added to the authentication system 120 in connection with the introduction of the interindividual sales system 122. In the steps S301 through S305 at the beginning of the second authentication processes, the authentication system 120 executes the same processes as steps S101 through S105 in the first authentication processes described above.

If deciding that the received combination of member ID and password is registered in the member management table 132 in step S304 corresponding to step S104, the authentication system 120 advances processes to step S306. In step S306, the authentication system 120 matches the received member ID against each of the seller IDs registered in the seller information table 133 and checks if or not the received member ID matches with any of the seller IDs registered in the seller information table 133. If the received member ID does not match with any of the seller IDs in the seller information table 133, the authentication system 120, in step S300, sends HTML data for displaying a screen (not shown) to warn that the operator of the accessing user terminal 2 is a member but is not yet registered as a seller to the browser 25 and then ends the processes.

On the contrary, if deciding that the received member ID does match with one of the seller IDS in the seller information table 133 in step S307, the authentication system 120 sends to the product registration CGI 1222 an answer that the operator of the accessing user terminal 2 is a member and is registered as a seller together with the member ID (seller ID) of this member.

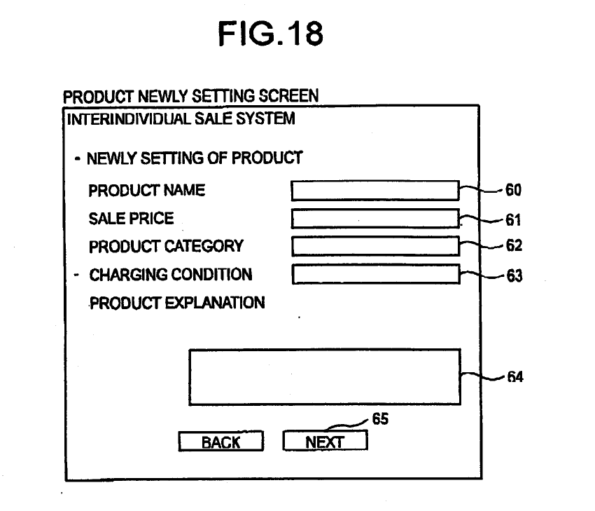

When it is confirmed that a member already registered as a seller accesses it, the product registration CGI 1222 sends, in next step S202, HTML data for displaying the product newly setting screen shown in FIG. 18 to the browser 25. This HTML data is incorporated with settings (i.e., form a tag) for indicating the product name box 605 the sale price box 61, the product category box 62, the charging condition box 63, the product explanation box 64 and the “next” button 65 in the screen as shown in FIG. 18 and for sending character strings respectively inputted to each of the boxes 60 through 64 as the product name, the sales price, the product category, the charging condition and the product explanation to the product registration CGI 1222 when the “next” button 65 is clicked. Therefore, in next step S203, the product registration CGI 1222 waits for each item of information to be sent from the browser 25.

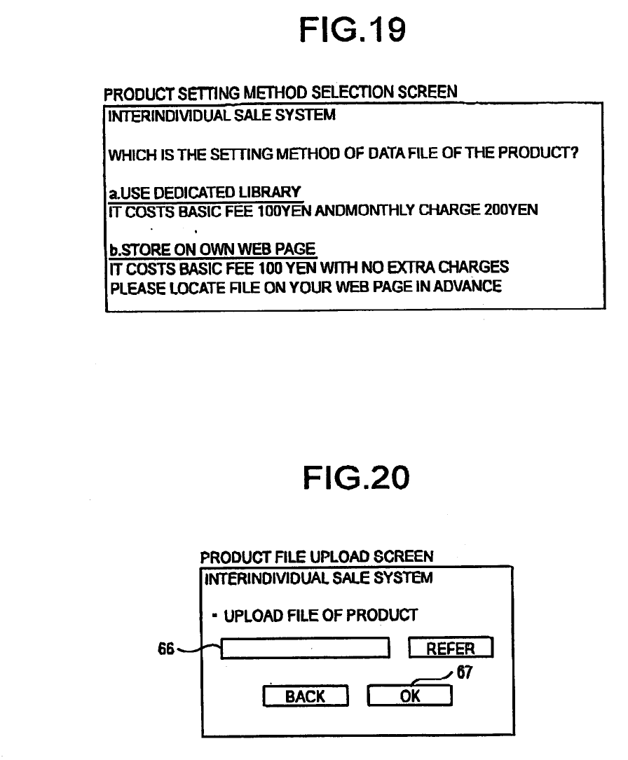

When receiving each item of information from the browser 25, the product registration CGI 1222 sends, in next step S204, HTML data for displaying the product installation method selection screen shown in FIG. 19 to the browser 25. The HTML data includes description for indicating alternatives, “a. utilize dedicated library” and “b. install at own HP” in the product installation method selection screen, and is incorporated with an action for notifying the product registration CGI 1222 of the parameter “selling condition”=“0” when the choice “a. utilize dedicated library” is clicked, and of the parameter “selling condition”=“1” when the choice “b. install at own HP” is clicked. Thereafter, in the next step S205, the product registration CGI 1222 waits for notification of the parameter “selling condition” from the browser 25. When there is notification of parameter “selling condition”=“0”, the process proceeds to step S206. When there is notification of parameter “selling condition”=“1”, the product registration CGI 1222 advances processes to S209.

In step S206, the product registration CGI 1222 sends HTML data for displaying the product file upload screen shown in FIG. 20 to the browser 25. The HTML data is incorporated with settings (i.e., a form tag) for indicating the file path box 66 and the “OK” button 67 in the screen as shown in FIG. 20 and for sending a file stored at a storage position within the hard disk 26 of the user terminal 2a indicating by the path name inputted to the file path box 66 when the “OK” button 67 is clicked. Therefore, in next step S203, the product registration CGI 1222 waits for a file (product file) to be sent from the browser 25.

When receiving a file (product file) from the browser 25, the product registration CGI 1222 stores, in the next step S208, the product file at some storage position within the library 136 and acquires a file path indicating this storage position. After step S208 is completed, the product registration CGI 1222 advances the processes to step S211.

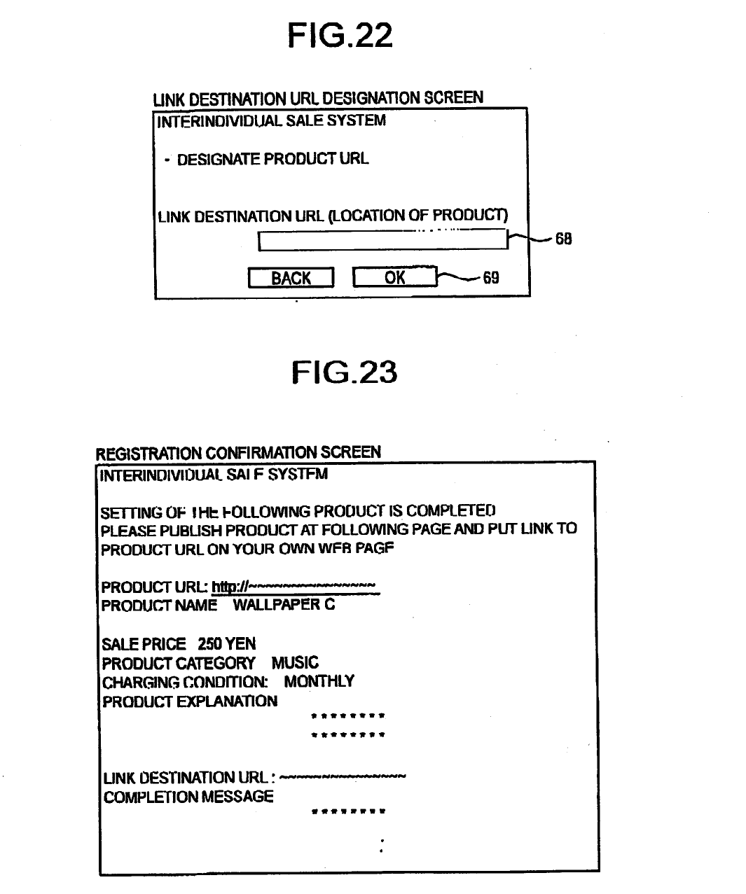

On the other hand, in step S209, the product registration CGI 1222 sends HTML data for displaying the link destination URL designation screen shown in FIG. 22 to the browser 25. The HTML data is incorporated with settings (i.e. a form tag) for indicating the link destination URL box 68 and the “OK” button 69 in the screen as shown in FIG. 22 and for sending a character string inputted to the link destination URL box 68 to the product registration CGI 1222 as a link destination URL when the “OK” button 69 is clicked. Therefore, in next step S210, the product registration CGI 1222 waits for these link destination URLs to be sent from the browser 25. When receiving the link destination URL from the browser 25, the product registration CGI 1222 advances processes to step S211.

In step S211, the product registration CGI generates a new product number and stores a new record including this product numbers the seller ID notified by the authentication system 120 in step S201, the product name, the sale price, the product category, the charging condition, and the product explanation received in step S203, the calling condition received in step S205, the product file received in step S207 or the link destination URL received in step S210, and the file path acquired in step S208 in the product information table 134.

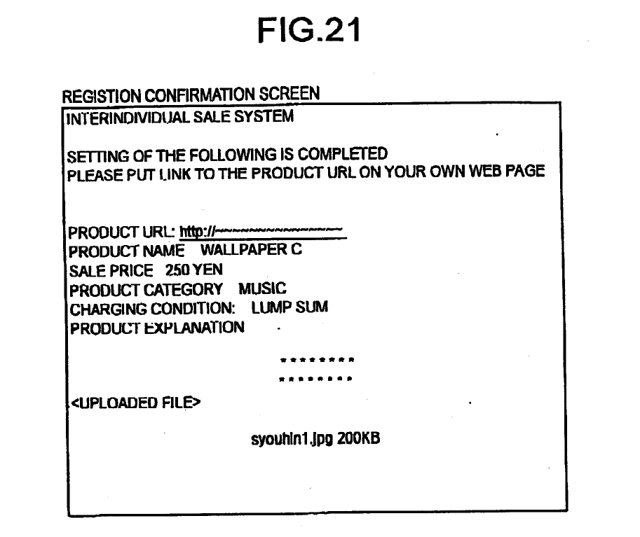

In next step S212, the product registration CGI 1222 generates a product URL including a URL for the sales CGI 1223 and product number generated in step S211 as a parameter to be passed over to the sales CGI 1223, dynamically generates HTML data for displaying a registration confirmation screen shown in FIG. 21 (for the case the selling condition=“0”) or in FIG. 23 (for the case the selling condition=“1”), and sends the HTML data to the browser 25, thereafter all of the processes ends. The product name, the sale price, the product category, the charging condition, the product explanation, the product file name (in the case of FIG. 21) or the link destination URL (in the case of FIG. 23) and the product URL in the record registered in the product information table 134 in step S211 are included in the registration confirmation screen.

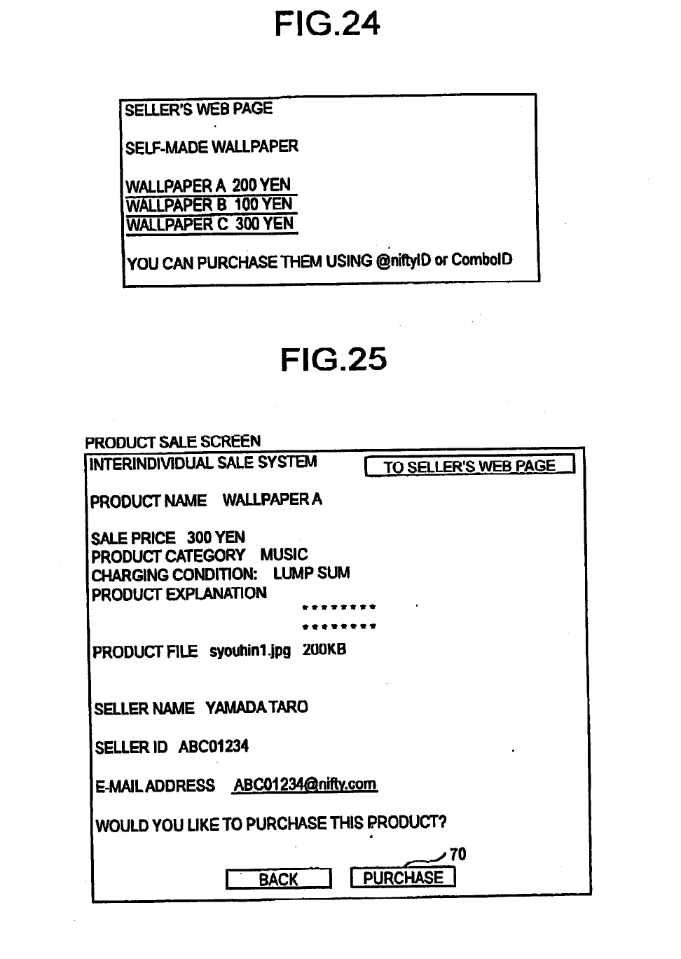

The seller once confirming the registration confirmation screen can set a link (an anchor tag including “href=the product URL”) to the product URL included in the registration confirmation screen in their own web page located at a web page region 131 within the hard disk 13 of the support server machine 1 or at a web site 31 of another web server machine 3. FIG. 24 shows an example of a web page in which such a link is set. In the web page shown in FIG. 24, there is provided the product PR “self-made wallpaper”, three combinations of wallpaper names (wallpaper A, wallpaper B and wallpaper C) and their sale prices, each of which is set with a link to a product URL for the product indicated by its product name. The seller may send an e-mail entered with the product URL included in the registration confirmation screen and its product PR directly to the e-mail address of a person thought likely to purchase the product corresponding to this product URL.

A member that has viewed the web page or the e-mail or this seller may click the product name or sale price of the product he or she wishes to purchase or directly input its product URL into their browser by operating the input device 23 of their own user terminal 2b. Then, the browser 25 running on the user terminal 2b sends an HTTP request message (which is the purchase request) designating this product URL to the WWW server 1220. The WWW server 1220 receiving this HTTP request message activates the sales CGI 1223 and passes the product number in the product URL over to the sales CGI 1223

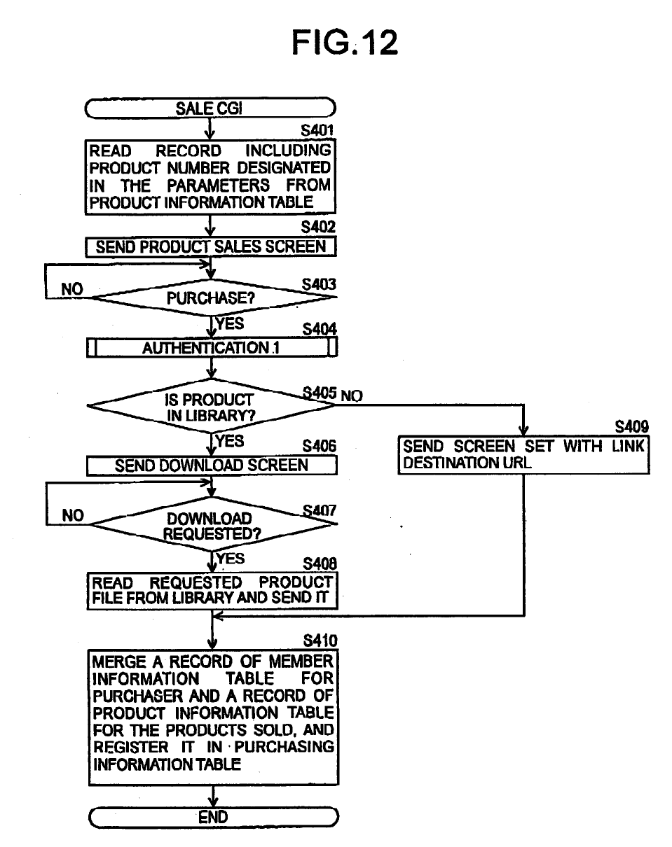

As shown in the flowchart in FIG. 12, thus activated sales CGI 1223 reads from the product information table 135 a record including the product number passed over from the WWW server 1220 as a parameter, in the first step S401.

In the next step S402, the sales CGI 1223 dynamically generates HTML data for displaying the product sales screen shown in FIG. 25 (for the case the selling condition=“0”) or FIG. 27 (for the case the selling condition=“1”) based on the record in the product information table 135 read out in step S401 and a record in the member management table 132 including a member ID matching with the seller ID included in that record, and sends this HTML data to the browser 25. In the product sales screen, the product name, the sale price, the product category, the charging condition, the product explanation, the product file name (only in the case of FIG. 25) and the seller ID included in the record read from the product information table 135 in step S401, the name (seller name) and e-mail address included in the record of the member management table 132 including the same member ID as the seller ID, and a “buy” button 70 are indicated. The HTML data is also incorporated with a setting for notifying the sales CGI 1223 of intent to buy the product when the “buy” button 70 is clicked. In the following step S403, the sales CGI 1223 waits for the notification from the browser 25.

When receiving the notification from the browser 25, the sales CGI 1223 requests, in next step 5404, the authentication system 120 for execution of the first authentication process. When the authentication system 120 certifies that the operator of the accessing user terminal 2b is a member, the sales CGI 1223 advances the processes to step S405.

In step S405, the sales CGI 1223 checks whether the selling condition included in the record read from the product information table 135 in step S401 is “0” (i.e. the library 136 is used) or “1” (i.e. the library is not used). The processes then advances to step S406 when the selling condition is “0” and to step S409 when the selling condition is “1”.

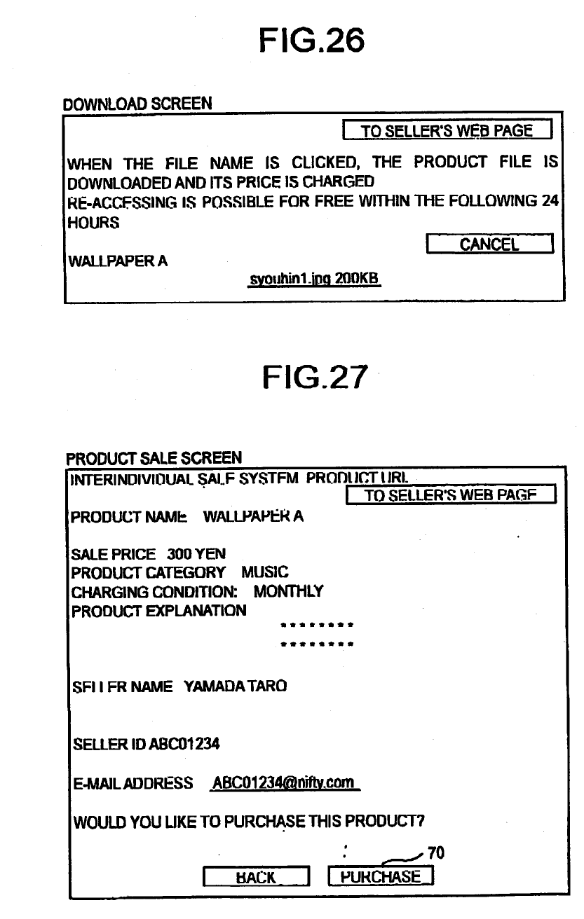

In step S406, the sales CGI 1223 dynamically generates HTML data for displaying the download screen shown in FIG. 26 and sends this HTML data to the browser 25. The HTML data is incorporated with settings for indicating the product name and product file name included in the record read from the product information table 135 in step S401 and for sending a download request designating the file path included in the same record to the sales CGI 1223 when the product file name is clicked. Therefore, in next step S407, the sales CGI 1223 waits for a download request designating the file path to be sent from the browser 25.

When receiving a download request from the browser 25, the authentication system 120 reads, in next step S400, the requested product file from the storage position within the library 136 specified by the file path designated in the download request and sends the product file to the browser 25. When step S408 is complete, the sales CGI 1223 advances the processes to step S410.

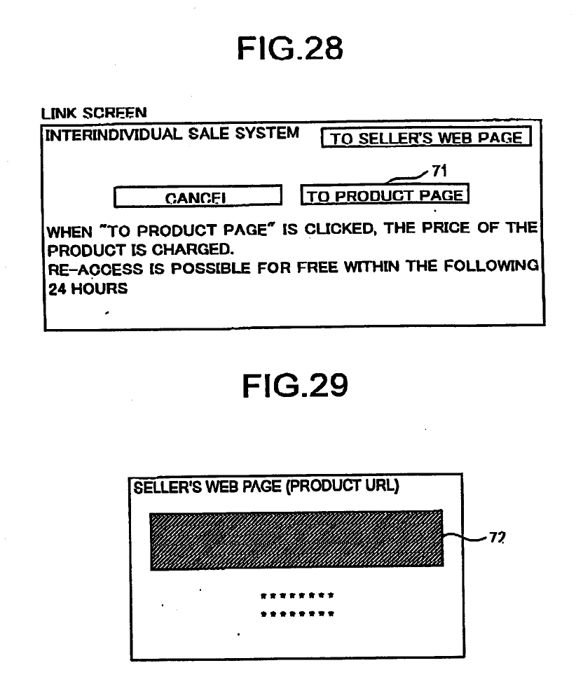

On the other hued, in step S409, the sales CGI 1223 dynamically generates HTML data for displaying the link screen shown in FIG. 28 and sends this HTML data to the browser 25. The HTML data is incorporated with a description for displaying the “to the product page” button 71 set with a link to the link destination URL included in the record read from the product information table 135 in step S401. Therefore, if clicking the “to the product page” button 71 in the link screen, the member as the purchaser can access and use the content 72 as the product to be purchased which in located within the seller's web page 130 or 1311 as shown in FIG. 29. When step S409 is complete, the sales CGI 1223 advances the processes to step S410.

In step S410, the sales CGI 1223 registers in the purchasing information table 135 new record generated by merging the record read from the product information table 135 in step S401 and the record read from the member management table 132 including the member ID matching with the seller ID in that record and by removing unnecessary items therefrom, for the sake of charging executed by the charging system described later (which corresponds to the processes for charging the purchaser the sale price), and thereafter completes the entire processes.

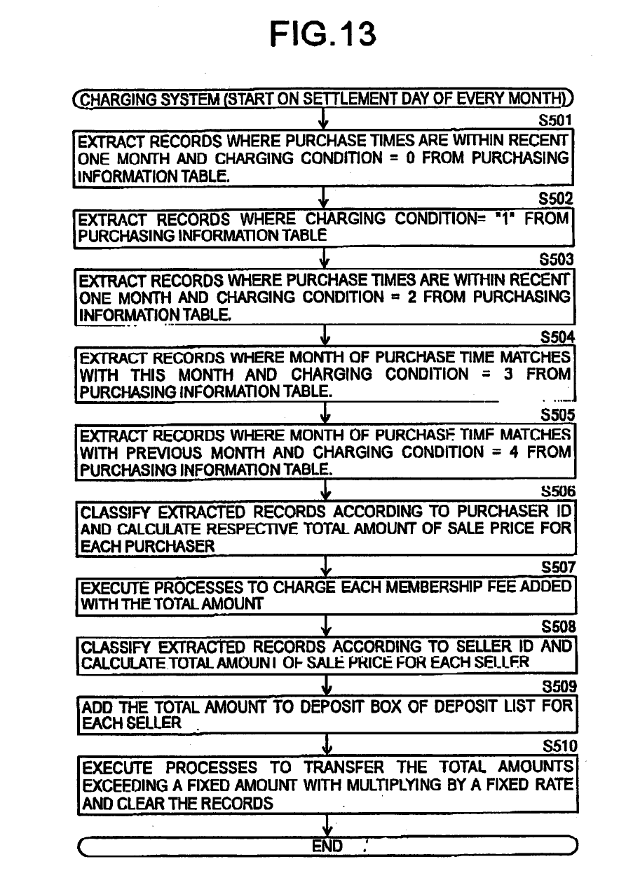

In parallel with the accumulation of records in the purchasing information table by appropriate activation of the CGIs 1221, 1222 and 1223 of the interindividual sales system 122, when a prescribed settlement day arrives each month, the charging system 121 executes the settlement processes shown in FIG. 13 on a predetermined settlement day of very month. This settlement processes is the existing processes of the charging system 121 for charging membership fee to each member added with those for settling a price or a product sold through the interindividual sales system 122.

In the first step S501 after starting the settlement processes, the charging system 121 extracts all records from the purchasing information table 135 of which purchase time is within the recent one month and of which charging condition “0”.

In next step S502, the charging system 121 extracts all records of which charging condition=“1” from the purchasing information table 135.

In next step S503, the charging system 121 extracts all records of which purchase time is within recent one month and of which charging condition=“2” from thc purchasing information table 135.

In next step S504, the charging system 121 extracts all records of which purchasing time belongs to same month an the processing day and of which charging condition=“3”, from the purchasing information table 135.

In next step S505, the charging system 121 extracts all records in which the month of the purchasing time matches the month previous to the month of the processing day and of which charging condition=“4” from the purchasing information table 135.

In next step S506, the charging system 121 classified all of the records extracted in steps S501 through S505 into groups each having respective purchaser ID and calculates the total sale price for each purchaser by summing the sale price in the group of records having his or her purchaser ID.

In the next step S507, the charging system 121 executes, for every member, processes (issuance of telegraphic message for charging and so on) for charging the credit card companies registered in the member management table 132 membership fee of the member, with designating his or her credit card number registered in the same table 132. In this time, the changing system 121 adds the total sale price for each purchaser calculated in step S506 to the membership fees for the purchaser who is a member and charges the credit card company the sum.

In next step S508, the charging system 121 classifies all of the records extracted in steps S501 through S505 into groups each having respective seller ID and calculates the total sale price for each seller by summing the sale prices in the group of records having his or her seller ID.

In the next step S509, the charging system 121 adds the total sale price for each seller calculated in step S508 to the deposited sale price box corresponding to the seller ID of the seller in the deposit list 137.

In next step S510, the charging system 121 checks the amounts of deposit for each seller ID in the deposit list 137. Thereafter, the charging system executes, for every deposit exceeding threshold amount (tar example, ten thousand yen), processes (issuance of telegraphic message for bank transfer) to transfer an amount calculated by multiplying the deposit by a fixed rate (for example, 0.9) to a bank account registered in the seller information table 133 for the corresponding seller ID, and then initializes the amount to zero yen. Multiplying the deposit by the fixed value is in order to subtract a part of the sale prices collected from the purchasers as a commission for the service provider. After completion or step S510, the charging system 121 ends this settlement processes.

According to the aforementioned settlement processes, when the deposit does not reach the threshold amount, it is not transferred to the sellers bank account, with being brought forward to the next month downward until it exceeds the threshold amount. This is to prevent relatively large part of the deposit from being deducted as commission for transfer. However, there are also cases, depending on the circumstances of the seller, where transfer is desired immediately. In such cases, the seller clicks the item for “transfer” displayed at the top page of the interindividual sale system shown in FIG. 7 on the display 22 of the user terminal 2a. As a result, an HTTP request message designating the URL of the bank transfer management CGI 1224 is sent to the WWW server 1220. The www server 1220 receiving the HTTP request message then activates the bank transfer management CGI 1224.

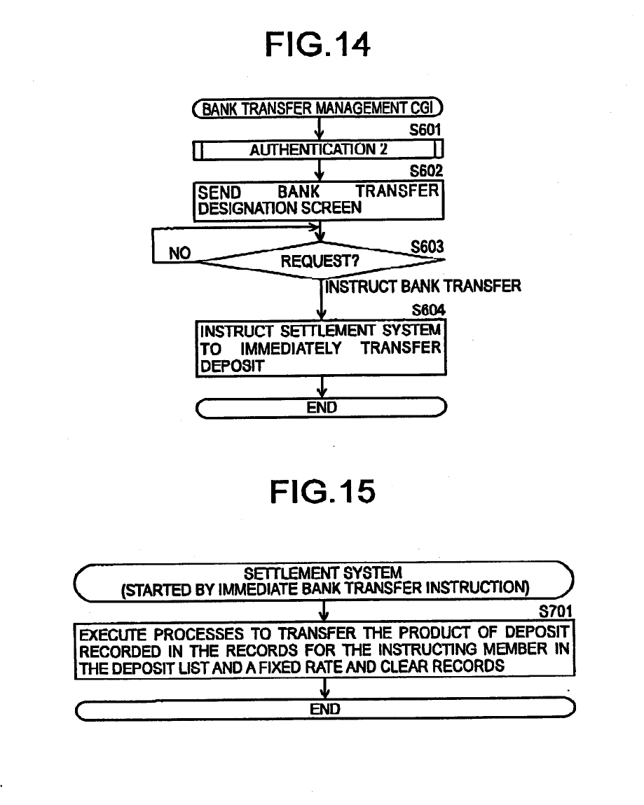

As shown in the flowchart in FIG. 14, the bank transfer management CGI 1224 thus activated makes a request to the authentication system 120 for execution of a second authentication processes, in a first step S601. When the authentication system 120 authenticates that the operator of the accessing user terminal 2a is a member registered in the seller information table 133 as a seller, the sales CGI 1223 advances the processes to step S602.

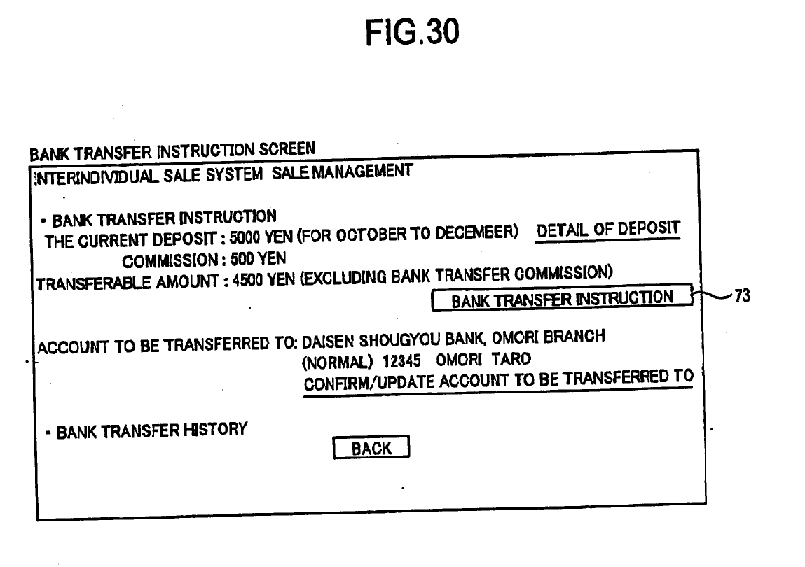

In step S602, the bank transfer management CGI 1224 dynamically generates HTML data for displaying a bank transfer instruction screen as shown in FIG. 30 based on information within the record in the seller information table 133 including the seller ID (member ID) authenticated by the authentication system 120 and the amount of deposit registered in the deposit list 137 for the seller ID and sends this HTML data to the browser 25. In the bank transfer instruction screen, the amount of deposit recorded in the deposit list 137, an amount calculated by multiplying the amount of deposit by a fixed rate (the transferable amount of money), and amount (commission) calculated by subtracting the transferable amount of deposit from the amount of the deposit, the pieces of information included in the record in the seller information table 133, which are the bunk name, the branch name, the account type, the account number and the account name, and the “bank transfer instruction” button 73 are indicated. The HTML data in incorporated with a setting for sending an instruction of this bank transfer to the bank transfer management CGI 1224 when the “bank transfer instruction” button 73 is clicked. In next step S603, the bank transfer management CGI 1224 waits for a bank transfer instruction to be sent by the browser 25.

When the bank transfer instruction is received from the browser 25, the bank transfer management CGI 1224 instructs, in next step S604, the charging system 121 to immediately transfer the amount of deposit for the seller ID (member ID) authenticated by the authentication system 120 and thereafter processes ends.

The charging system 121 thus instructed executes the immediate bank transfer processes shown in FIG. 15. This immediate bank transfer processes is a function added to the charging system 121 for executing the individual settlement method.

In the first step S701 of the immediate bank transfer processes, the charging system 121 executes processes (issuance of a telegraphic message for the bank transfer, etc.) for transferring an amount of the product of the deposit recorded in the deposit list 137 corresponding to the seller ID (member ID) instructed from the bank transfer management CGI 1224 and the fixed rate to the bank account correspondingly recorded in the seller information table 133 for this seller ID. The deposit recorded in the deposit list 137 is then initialized to zero yen. The charging system 121 then ends the immediate bank transfer processes as a result of ending the step S701.

As described above, in the network system of this embodiment, people who wish to sell their own content to other people may become a member of an internet connection service or pay content providing service by entering into a contract with a service provider administering the support server machine 1 for the service, so that he or she can have interindividual sales system 122 collect sales prices for the content from purchasers, regardless of the location of the content that is the target of the sales, only by undertaking a simple procedure. Namely, if the people uploads the content to be sold to a library 136 or notifies the interindividual sales system 122 (product registration CGI 1222) of a link destination URL indicating the position where the content to be sold is stored with designating its sale price, then a unique product number is generated for this content, a record defining correspondence between the path to the content in the library 136 or the link destination URL and the product number is registered in the product information table 134, and a product URL consisting of the URL of the sales CGI 1223 and the product number as a parameter is issued. The people may then advertise the content they wish to sell freely to a broad range of people by writing a link to this product URL in any web page including their own web pages. When people who wish to purchase the content find an item indicated by the link to the product URL on a web page then click the item or directly input this product URL to a browser 25, the sales CGI 1223 is immediately activated by the WWW server 1220 and the product number is passed over as a parameter. The activated sales CGI 1223 then reads out the path or link destination URL and sale price corresponding to this product number from the product information table 134 and notifies the purchaser of the path or the link destination URL to enable the purchaser to download or to access the content. Thereafter, the sales CGI 1223 executes processes to charge sale price to the purchaser.

Further, according to this embodiment, the seller can enjoy the advantage that the degree of freedom of location where the content to be sold can be stored is increased, and the purchaser can enjoy the advantage that he or she complete all the procedure to purchaser the content simply by sending an HTTP message designating the product URL, without searching for the content to be purchased after authentication.

Further, according to this embodiment, it is possible for the seller to select one of charging conditions prepared when the seller uploads the content to be sold to the library 136 or notifies the interindividual sales system 122 of the link destination URL indicating the storage position where this content is stored. It Is therefore possible to adopt various situations for charging according to the attributes of the content to be sold and the hopes of the seller themselves. For example, periodic charging such as monthly charging or yearly charging can be selected in the case of a content such as an electric bulletin board which is occasionally updated, pay web pages and a computer program.

In this embodiment, programs 1221 through 1224 other than the WWW server 1220 comprising the interindividual sales system 122 are programmed as CGI programs but the same functions may also be implemented using Java (trademark of Sun Microsystems) servlet.

According to the present invention, a charging method reflecting the intent of the seller or reflecting the attributes of a content to be sold can be arbitrarily selected and set by the seller.

We claim:

1. An interindividual settlement support method for mediating in purchasing a content between individuals and for charging a purchaser its sale price via a network, said method comprising steps of:
enabling on a computer execution of a first program of processes for communicating with terminals to mediate in purchasing a content between individuals and a second program of processes for charging a purchaser sale price of the content;
wherein said first program makes the computer stores identification information, and information indicating a sale price and a charging condition for a content requested by a seller in a first storage device with them corresponding each other, and reads when receiving a purchase request designating the identification information from a terminal operated by a purchaser, information indicating the sale price and charging condition corresponding to this identification information from the first storage device to store a record including the the purchaser in a second storage device; and
wherein said second program makes the computer charge the purchaser indicated by the identification information the sale price indicated by the information according to the charging condition indicated by the information, said prices of information being included in same record stored in the second storage device.

2. The interindividual settlement support method according to claim 1, wherein the charging condition includes charging the purchaser the sale price in a lump at the time of purchasing.

3. The interindividual settlement support method according to claim 1, wherein the charging condition includes repeatedly and periodically charging for the sale price.

4. The interindividual settlement support method according to claim 1, wherein the charging condition includes repeatedly and periodically charging for the sale price after a proscribed period of time has elapsed from the time of purchasing.

5. The interindividual settlement support method according to claim 1, wherein the first program further makes the computer acquire information indicating the sale price and the charging condition sent from the terminal operated by the seller and generates unique identification information.
